(19) United States
(12) Patent Application Publication
(10) Pub. No.: US 2016/0009066 A1
(43) Pub. Date: Jan. 14, 2016

(54) SYSTEM AND METHOD FOR CUTTING LAMINATED STRUCTURES

(71) Applicant: Corning Incorporated, Corning, NY (US)

(72) Inventors: Albert Roth Nieber, Painted Post, NY (US); Sergio Tsuda, Horseheads, NY (US)

(21) Appl. No.: 14/798,544

(22) Filed: Jul. 14, 2015

Related U.S. Application Data
(60) Provisional application No. 62/024,035, filed on Jul. 14, 2014.

(51) Int. Cl. B32B 37/14; B32B 38/18

(52) U.S. Cl. CPC B32B 37/14; B32B 38/18; B32B 2310/00

(57) ABSTRACT

The present invention is directed to a system and method for processing a laminated structure having a plurality of laminate layers. The system includes a laser assembly that provides a plurality of laser burst emissions having predetermined laser characteristics and an optical assembly that focuses each laser burst emission to a predetermined focal line. The method selects laser characteristics and focal line parameters for each laser burst emission such that a defect having predetermined dimensions is formed at a predetermined location within the laminated structure. The laminated structure moves in relation to the optical assembly such that the plurality of laser burst emissions form a plurality of said defects corresponding to a multi-dimensional defect pattern within the laminated structure, each said defect being substantially generated by induced absorption.

This application claims the benefit of priority under 35 U.S.C. §119 of U.S. Provisional Application Ser. No. 62/024,035 filed on Jul. 14, 2014, the content of which is relied upon and incorporated herein by reference in its entirety.

### BACKGROUND

A laminate structure is formed by bonding multiple layers of materials together in order to provide a product that is stronger and offers improved functionality over similar non-laminate products. Manufacturers can tailor the optical, mechanical, thermal and electrical properties of a laminate structure by using various materials in suitable amounts in the various layers. For example, materials such as glass, ceramics, PTFE, polymers, thin film transistors, electrode materials, sapphire and the like may be used to implement individual laminate layers. As described below, an individual layer can be doped or infused with other materials in order to enhance the material characteristics of that layer. Once the individual layers, or plys, are assembled, the composite structure is fused by some combination of heat, pressure and/or adhesives.

Glass laminates are used in a variety of applications. For example, a layer of plastic material may be disposed between two glass substrates to form a vehicle windshield. Vehicle windshields are commonly made by laminating a tough plastic film between two layers of glass. Glass laminates are also employed in the construction of homes and buildings. Architectural glass laminates, for example, are used to provide external and internal windows, interior partitions and other types of transparent architectural features. Both architectural glass laminates and automotive glass laminates must be engineered with safety in mind. Accordingly, both of these applications use reinforced and toughened laminated glasses.

One example of a toughened glass is the so-called Gorilla glass developed by Corning Incorporated. (Gorilla glass is a registered trademark for a toughened glass product that exhibits exceptional hardness properties). In the Gorilla glass process, the glass material is immersed in a molten alkaline salt bath using ion exchange to produce an alkali-aluminosilicate glass sheet. The resultant glass sheet has a compressive residual stress at the surface of the glass that increases the hardness of the material. The residual stress prevents cracks from forming and propagating in the material. As a result, this type of glass is well suited for use in architectural glass, automotive glass, and other laminate applications.

In addition to being damage resistant, toughened glass materials such as Gorilla glass can also be made in glass sheets that are both light and thin. Accordingly, such materials may also be used as a cover glass for electronic devices such as mobile phones, portable media players, laptop computer displays, and television screens. Sapphire is another material that may be employed for this purpose. (As those skilled in the art will appreciate, sapphire is a crystalline form of aluminum oxide). A cover glass may be produced by fusing together a first glass sheet and a second glass sheet, or by fusing a first sapphire sheet and a second sapphire sheet, to form a hardened and tough glass laminate structure.

Another type of composite structure that is commonly used in electronic device applications is display glass. Display glass is so named because it is a composite structure that includes the optics and electronics that are used to display visual images on an electronic device screen. One example of a display glass structure is a thin-film transistor (TFT) display matrix. In general, the TFT display matrix includes two sheets of very pure glass with a layer of twisted nematic liquid crystal disposed therebetween. The liquid crystal material is further disposed between two layers of rigid transparent plastic; this “sandwich” may also include spacer elements for structural stability. The underside of the top sheet of glass may include a color mask having red, green, and blue (RGB) elements that provide color for each pixel element. The upper side of the top sheet of glass may be coated with a light polarizing sheet of material. An interior major surface of the second glass sheet (i.e., the one facing the liquid crystal material) typically includes the electronics—a matrix of TFTs interconnected by horizontal and vertical command lines. The TFTs are comprised of transparent semiconductor materials and the electrodes and interconnections are made from transparent conductive materials such as indium tin oxide (ITO). The other side of the second glass sheet may also include a light polarizing layer of material. Display glass is, therefore, a rather sophisticated structure that must be processed with great care.

Glass substrates have also been used to support micro-electrical-mechanical system (MEMS) devices and nano-electrical-mechanical system (NEMS) devices. MEMS and NEMS devices may include a microprocessor, microsensor and/or micro actuator elements. These elements may be fabricated using semiconductor and other thin-film materials. Accordingly, these devices may be implemented using the same, or similar, semiconductor device fabrication techniques that are used to make electronic devices. The MEMS/NEMS substrates are often disposed on glass substrates and may include additional (e.g., insulative) layers to form a composite laminate structure. Like display glass applications, NEMS/MEMS devices are sensitive and can be easily damaged by vibration and other such stresses.

The above list of laminate devices is not exhaustive. Those skilled in the art will appreciate that many RF components are also produced using laminate layers such as glasses, ceramics, PTFE materials, conductive materials and the like. Like many of the above applications (e.g., display glass, MEMS/NEMS, cover glass, etc.), these devices are manufactured in rather large sheets that include many individual components. Accordingly, these large sheets must be cut, divided and/or singulated to obtain the individual laminated products.

In recent years, precision micromachining and its improvement of process development to meet customer demand to reduce the size, weight and material cost of leading-edge devices has led to fast pace growth in high-tech industries in flat panel displays for touch screens, tablets, smartphones and TVs, where ultrafast industrial lasers are becoming important tools for applications requiring high precision.

There are various conventional ways to cut laminate structures using mechanical means such as cutting blades, plasma jets, etc. Due to the sensitive nature of many of these laminated components, mechanical cutting methods often result in damaged products. As such, these mechanical methods are insufficient and wasteful. Moreover, the blade cutting techniques result in the generation of an excessive amount of debris. As a result, many manufacturers employ laser cutting techniques to divide and singulate large laminate sheets or products. In conventional laser cutting processes, the separation of laminate workpiece relies on laser scribing or perforation followed by separation with mechanical force or thermal stress-induced crack propagation. Nearly all current laser cutting techniques exhibit one or more shortcomings, including:

(1) Limitations in their ability to perform a free form shaped cut of thin glass on a carrier due to a large heat-affected zone (HAZ) associated with the long laser pulses (nanosecond scale or longer) used for cutting,

(2) Production of thermal stress that often results in cracking of the glass surface near the region of laser illumination due to the generation of shock waves and uncontrolled material removal,

(3) Creation of sub-surface damage in the glass that extends hundreds of microns (or more) glass below the surface of the glass, resulting in defect sites at which crack propagation can initiate, and

(4) Difficulties in controlling the depth of the cut (e.g., to within tens of microns).

What is needed therefore is a system and method for cutting laminate structures without the drawbacks described above.

### SUMMARY

The present invention is directed to a system and method for cutting laminate structures that overcomes the drawbacks described above. The system and method of the present invention is configured to perform a free form shaped cut of thin glass on a carrier without being limited by large heat-affected zones (HAZ) associated with the long laser pulses. Moreover, the present invention avoids the production of thermal stress that often results in cracking of the glass surface near the region of laser illumination due to the generation of shock waves and uncontrolled material removal. In addition, the present invention substantially prevents creation of sub-surface damage in the glass that extends hundreds of microns (or more) glass below the surface of the glass. As a result, uncontrolled and randomized defect sites that typically result in damaging crack propagation are substantially prevented. The system and method of the present invention can easily control the depth of each individual cut to within tens of microns.

One embodiment is directed to a system for processing a laminated structure, the laminated structure having a plurality of laminate layers. The system includes a laser assembly configured to provide a plurality of laser burst emissions, each laser burst emission of the plurality of laser burst emissions having predetermined laser characteristics. An optical assembly is coupled to the laser assembly. The optical assembly is configured to focus each laser burst emission to a predetermined focal line. The optical assembly is adjustable such that each predetermined focal line is characterized by predetermined focal line parameters and disposed at a predetermined position relative to the optical assembly. A workpiece holder is configured to hold the laminated structure, the workpiece holder or the optical assembly being configured to provide a relative motion between the laminated structure and the optical assembly. A controller is coupled to the laser assembly, the optical assembly or the workpiece holder. The controller is configured to dynamically select the predetermined laser characteristics and the predetermined focal line parameters for each laser burst emission such that a defect having predetermined dimensions is formed at a predetermined location within the laminated structure. The controller is further configured to select the relative motion such that the plurality of laser burst emissions form a plurality of said defects corresponding to a three-dimensional defect pattern within the laminated structure, each said defect being substantially generated by induced absorption.

Another embodiment includes a method that includes the step of providing a laminated structure including a plurality of laminate layers, a first portion of the plurality of laminate layers being transparent at a first optical wavelength and at least one second portion of the plurality of laminate layers being transparent at at least one second optical wavelength. A first laser beam and at least one second laser beam are selectively directed, respectively, toward the laminated structure, the first laser beam being characterized by the first wavelength and the at least one second laser beam being characterized by the at least one second wavelength. The first laser beam is selectively focused at a plurality of first predetermined focal lines while moving the laminated structure relative to the first laser beam to form a first three-dimensional defect pattern in the first portion by induced absorption. The at least one second laser beam is selectively focused at a plurality of second predetermined focal lines while moving the laminated structure relative to the at least one second laser beam to form at least one second three-dimensional defect pattern in the at least one second portion by induced absorption. The first three-dimensional defect pattern and the at least one second three-dimensional defect pattern forming a composite defect pattern within the laminated substrate.

Yet another embodiment includes a method for processing a laminated structure, the laminated structure comprising a plurality of laminate layers. The method includes providing a system that includes a laser assembly configured to provide a plurality of laser burst emissions, each laser burst emission of the plurality of laser burst emissions having laser characteristics. The system further includes an optical assembly coupled to the laser assembly, the optical assembly being configured to focus each laser burst emission to a predetermined focal line. The optical assembly is adjustable such that each predetermined focal line is characterized by focal line parameters and disposed at a predetermined position relative to the optical assembly. The laser characteristics and the focal line parameters are selected for each laser burst emission such that a defect having predetermined dimensions is formed at a predetermined location within the laminated structure. A relative motion is effected between the laminated structure and the optical assembly, the relative motion being selected such that the plurality of laser burst emissions form a plurality of said defects corresponding to a multi-dimensional defect pattern within the laminated structure, each said defect being substantially generated by induced absorption.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is a block diagram of a system for cutting laminated structures in a accordance with an embodiment of the present invention;

FIG. 2 is a cross-sectional view of an optical system in accordance with one embodiment of the present invention;

FIG. 3 is a cross-sectional view of an optical system in accordance with a second embodiment of the present invention;

FIGS. 4A-4B are a cross-sectional views of an optical system in accordance with a third embodiment of the present invention;

FIG. 5 is a cross-sectional view of an optical system in accordance with a fourth embodiment of the present invention;

FIG. 6 is a diagram illustrating the laser burst emission frame structure in accordance with an embodiment of the present invention;

FIG. 7 is a diagram illustrating a method for cutting laminated structures in a accordance with an embodiment of the present invention;

FIGS. 8A-8F are detailed diagrams illustrating the system and method for cutting laminated structures in a accordance with another embodiment of the present invention;

FIGS. 9A-9C are cross-sectional views illustrating the various process steps depicted in FIGS. 8A-8F;

FIG. 10 is a cross-sectional diagram illustrating various types of laminate cuts performed by the system and method of the present invention;

FIG. 11 is a cross-sectional diagram illustrating other types of laminate cuts performed by the system and method of the present invention;

FIG. 12 is a cross-sectional diagram illustrating certain glass laminate cuts performed by the system and method of the present invention;

FIGS. 13A-13D include various diagrammatic views illustrating additional types of laminate cuts performed by the system and method of the present invention; and

FIGS. 14A-14B include various diagrammatic views illustrating additional types of three-dimensional glass laminate cuts performed by the system and method of the present invention.

### DETAILED DESCRIPTION

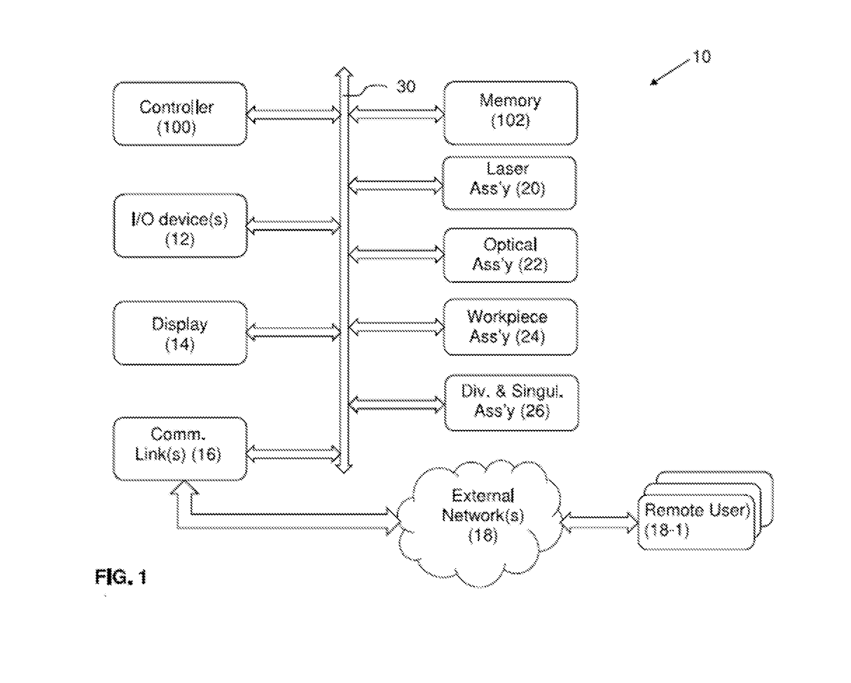

Reference will now be made in detail to the present preferred embodiments, examples of which are illustrated in the accompanying drawings. Whenever possible, the same reference numerals will be used throughout the drawings to refer to the same or like parts. One embodiment of the system for cutting laminated structures is shown in FIG. 1, and is designated generally throughout by the reference numeral 10.

As embodied herein and depicted in FIG. 1, a block diagram of a system 10 for cutting laminated structures in accordance with the present invention is disclosed. The system 10 includes a controller 100 and memory 102 that are coupled to a system bus 30. The controller 100 may include integrated memory or employ external memory integrated chips. The bus 30 is also connected to I/O device(s) 12 and one or more display devices 14 as needed. The system 10 may include one or more communication link circuits 16 that are configured to provide duplex communications to one of more remote users 18-1 via an eternal network 18. The system further includes a laser assembly 20, an optical assembly 22 and a workpiece assembly 24 that are under the control of controller 100 via the bus system 30. Once the pattern of defects is formed in the laminate structure 1, the controller 100 may use a divide and singulate assembly 26 to divide the laminate substrate into laminate components. In an alternate embodiment, the laminate structure may be shipped to the customer with the defect pattern formed therein; it may be more cost effective or efficient for the customer to divide and singulate.

As described herein, the laser assembly 20 includes multiple lasers having different wavelengths in order to accommodate diverse laminate substrate layers in the laminate substrate 1. Thus, the present invention provides wavelength selectivity for various materials. The optical system 22 may include one or more optical elements configured to focus to a focal line (not a spot) having a predetermined length. The optical assembly 22 is further configured to position the focal line at a precise location within the substrate such that an individual laminate layer (or portion of a layer) can be precisely cut as needed. The controller 100 is configured to dynamically operate the optical assembly 22 such that focal lines of varying lengths are formed at different depths in accordance with a product specification. The workpiece assembly 24 is also configured to be operated by the controller 100 to move the laminate in the x-y plane in accordance with the product specification. Thus, the controller is programmed and/or configured to orchestrate the laser assembly 20, the optical assembly 22 and the workpiece assembly 24 in order to precisely form a plurality of defects (micro-cracks, segmented perforations or channels) corresponding to a three-dimensional defect pattern within the laminated structure. Each defect is generated by induced absorption in order to eliminate large heat-affected zones. Each system element shown in FIG. 1 is described in greater detail below.

The term “controller” is generally used herein to describe various arrangements relating to performing the method for cutting laminate structures in accordance with the present invention. The controller 100 can be implemented in numerous ways (e.g., such as with dedicated hardware) to perform various functions discussed herein. A “processor” is one example of a controller which employs one or more microprocessors that may be programmed using software (e.g., firm ware or microcode) to perform various functions discussed herein. A controller may be implemented with or without employing a processor, and also may be implemented as a combination of dedicated hardware to perform some functions and a processor (e.g., one or more programmed microprocessors and associated circuitry) to perform other functions. Examples of processor components that may be employed in various embodiments of the present disclosure include, but are not limited to, conventional microprocessors, reduced instruction set computers (RISC), application specific integrated circuits (ASICs), field-programmable gate arrays (FPGAs) and the like. The controller 100 can be configured to send and receive data, including program code, through the bus 30, the communications interface 16, and the network(s) 18. In this example, a server computer (i.e., 18-1) may transmit instructions in order to implement an embodiment of the present invention. The controller 100 may execute the transmitted code while it is being received and/or store the code in memory, or in other non-volatile storage for later execution.

As noted above, the controller 100 may include memory 102 and one or more processors operable to execute instructions, stored in the memory, to perform the methods described herein. The memory 102 typically includes volatile and non-volatile computer memory such as RAM, PROM, EPROM, and EEPROM, floppy disks, compact disks, optical disks, magnetic tape, etc. In some implementations, the memory (i.e., firmware) may be encoded with one or more programs that, when executed on one or more processors and/or controllers, perform at least some of the functions discussed herein. Various storage media may be fixed within a processor or controller or may be transportable, such that the one or more programs stored thereon can be loaded into a processor or controller so as to implement various aspects of the present invention discussed herein. The terms “program” or “computer program” are used herein in a generic sense to refer to any type of computer code (e.g., software or microcode) that can be employed to program one or more processors or controllers.

The term “computer-readable medium” as used herein refers to any medium that participates in providing data and/or instructions to the processor for execution. Such a medium may take many forms, including but not limited to non-volatile media, volatile media, and transmission media. Non-volatile media include, for example, solid state devices, and optical or magnetic disks. Volatile media include dynamic memory devices. Transmission media may include coaxial cables, copper wire and fiber optic media. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

The high speed digital bus 30 is configured to provide duplex data communications between the controller 100 and the other components of the system 10. The digital bus 30 includes a data bus configured to transmit data between the controller 100 and the other system components (12, 14, 16, 18, 20, 22, 24 and 102). The digital bus 30 further includes an address bus to determine where data should be sent, and a control bus that provides the component with the operation that the controller wants to be carried out.

The I/O devices 12 provide an interface between human users and the system 10. Input devices may also include, inter alia, keyboards including alphanumeric and other keys for communicating information and command selections to the cluster 16. Other examples of other input devices that may be employed in various implementations of the present disclosure include, but are not limited to, switches, potentiometers, buttons, dials, sliders, a mouse, keyboard, keypad, various types of joysticks, track balls, display screens, various types of graphical user interfaces (GUIs), or touch screens. With respect to display devices 14, users may be provided with output devices such as a cathode ray tube (CRT), liquid crystal display, active matrix display, or plasma display for displaying operational data related to the laminate cutting operation.

The external communication interface 16 allows the system 10 to provide remote locations and remote users with system data and analysis in real time or otherwise. The communication interface 16 may include hardware network access card(s) and/or driver software necessary for connecting the ground station to the external network fabric. The communications interface may be implemented using any suitable arrangement such as the public switched telephone network (PSTN), a digital subscriber line (DSL) card or modem, an integrated services digital network (ISDN) card, a cable modem, a telephone modem, or any other communication interface that provides a data communication connection to a corresponding type of communication line. The communication interface 16 may also interface a local area network (LAN) or a wide area network (WAN) using, e.g., Ethernet™ or Asynchronous Transfer Mode (ATM) cards. Communications interface 16 may also provide interconnections to the global packet data communication network now commonly referred to as the Internet. Wireless links can also be used to implement interface 16. In any such implementation, communication interface 16 may be configured to transmit and receive electrical, electromagnetic, or optical signals that carry digital data streams representing various types of information.

Further, the communication interface 210 can include peripheral interface devices, such as a Universal Serial Bus (USB) interface, a PCMCIA (Personal Computer Memory Card International Association) interface, etc. Although a single communication interface 210 is depicted in FIG. 1, multiple communication interfaces can also be employed.

The network 18 as used herein refers to any interconnection of two or more devices that facilitates the transport of information (e.g. for device control, data storage, data exchange, etc.) between any two or more devices and/or among multiple devices coupled to the network. As should be readily appreciated, various implementations of networks 18 suitable for interconnecting multiple devices may include any of a variety of network topologies and employ any of a variety of communication protocols. Additionally, in various networks according to the present disclosure, any one connection between two devices may represent a dedicated connection between the two systems, or alternatively a non-dedicated connection. Furthermore, it should be readily appreciated that various networks 18 discussed herein may employ one or more wireless, wire/cable, and/or fiber optic links to facilitate information transport throughout the network 18.

As described herein, the laser assembly 20 is configured to provide multiple lasers having different wavelengths in order to accommodate diverse laminate substrate layers. For example, the laser assembly may include, but is not limited to, lasers providing beam wavelengths at 266, 355, 532, and 1064 nanometers (nm). The laser selection is in fact determined by the materials used to implement the laminate layers. Stated differently, the laser wavelength is selected such that the material is transparent at that wavelength. As described in greater detail below, the system 10 is configured to dynamically select the various lasers in the laser assembly 20 in order to produce high precision cuts in or through materials that are transparent at the selected laser wavelength. Sub-surface damage is thus limited to the order of 60 microns in depth or less, and the cuts may produce only a small amount of debris.

As described herein, a material is substantially transparent to the laser wavelength when the linear absorption is less than about 10%, preferably less than about 1% per mm of material depth at this wavelength. In one embodiment, the material to be processed by the laser is transparent to the laser wavelength if it absorbs less than 10% of the intensity of the laser wavelength per mm of thickness of the material. In another embodiment, the material to be processed by the laser is transparent to the laser wavelength if it absorbs less than 5% of the intensity of the laser wavelength per mm of thickness of the material. In still another, the material to be processed by the laser is transparent to the laser wavelength if it absorbs less than 2% of the intensity of the laser wavelength per mm of thickness of the material. In yet another embodiment, the material to be processed by the laser is transparent to the laser wavelength if it absorbs less than 1% of the intensity of the laser wavelength per mm of thickness of the material.

The dynamic selection of the laser source 20 and the optical assembly (22) setting are predicated on the ability to induce multi-photon absorption (MPA) in the transparent material. In one embodiment of the invention, the optical assembly 22 is driven by the controller 100 to provide a Bessel beam having a predetermined focal line length positioned at a precise location. The Bessel beam instantaneously forms a defect over the full extent of the focal line. Thus, instead of drilling through a material by focusing at a spot, the Bessel beam precisely and simultaneously ionizes the material only where the focal line is formed by the optics 22. Moreover, the diameter of the defect is substantially equal to the diameter of the focal line.

MPA is the simultaneous absorption of multiple photons of identical or different frequencies in order to excite a material from a lower energy state (usually the ground state) to a higher energy state (excited state). The excited state may be an excited electronic state or an ionized state. The energy difference between the higher and lower energy states of the material is equal to the sum of the energies of the multiple absorbed photons. MPA is a third-order nonlinear process that is several orders of magnitude weaker than linear absorption. It differs from linear absorption in that the strength of absorption depends on the square of the light intensity, thus making it a nonlinear optical process. At ordinary light intensities, MPA is negligible. If the light intensity (energy density) is extremely high, such as in the region of focus of a laser source (particularly a pulsed laser source), MPA becomes appreciable and leads to measurable effects in the material within the region where the energy density of the light source is sufficiently high. Within the focal region, the energy density may be sufficiently high to result in ionization.

At the atomic level, the ionization of individual atoms has discrete energy requirements. Several elements commonly used in glass (e.g., Si, Na, K) have relatively low ionization energies (˜5 eV). Without the phenomenon of MPA, a wavelength of about 248 nm would be required to create linear ionization at ˜5 eV. With MPA, ionization or excitation between states separated in energy by ˜5 eV can be accomplished with wavelengths longer than 248 nm. For example, photons with a wavelength of 532 nm have an energy of ˜2.33 eV, so two photons with wavelength 532 nm can induce a transition between states separated in energy by ˜4.66 eV in two-photon absorption (TPA), for example.

Thus, atoms and bonds can be selectively excited or ionized in the regions of a material where the energy density of the laser beam is sufficiently high to induce nonlinear TPA of a laser wavelength having half the required excitation energy, for example. MPA can result in a local reconfiguration and separation of the excited atoms or bonds from adjacent atoms or bonds. The resulting modification in the bonding or configuration can result in non-thermal ablation and removal of matter from the region of the material in which MPA occurs. This removal of matter creates a structural defect (e.g. a “defect line,” a “segment” or a “perforation”) that mechanically weakens the material and renders it more susceptible to cracking or fracturing upon application of mechanical or thermal stress.

Perforations can be accomplished with a single “burst” of high energy short duration pulses spaced close together in time. The laser pulse duration may be 10⁻¹⁰ s or less, or 10⁻¹¹ s or less, or 10⁻¹² s or less, or 10⁻¹³ s or less. These “bursts” may be repeated at high repetition rates (e.g. kHz or MHz). The perforations may be spaced apart and precisely positioned by controlling the velocity of a substrate or stack relative to the laser through control of the motion of the laser and/or the substrate or stack.

As an example, in a thin transparent substrate moving at 200 mm/sec exposed to a 100 kHz series of pulses, the individual pulses would be spaced 2 microns apart to create a series of perforations separated by 2 microns. This defect (perforation) spacing is sufficient close to allow for mechanical or thermal separation along the contour defined by the series of perforations.

In accordance with methods described below, in a single pass, a laser can be used to create highly controlled full line perforation through the laminate material, with extremely little (<75 μm, often <50 μm) subsurface damage and debris generation. This is in contrast to the typical use of spot-focused laser to ablate material, where multiple passes are often necessary to completely perforate the glass thickness, large amounts of debris are formed from the ablation process, and more extensive sub-surface damage (>100 μm) and edge chipping occur. Thus, it is possible to create a microscopic (i.e., <0.5 μm and >100 nm in diameter) elongated “hole” or channel (also referred to herein as a perforation or a defect line) in transparent material using a single high energy burst pulse (See, FIG. 6). These individual perforations can be created at rates of several hundred kilohertz (several hundred thousand perforations per second, for example). Thus, with relative motion between the source and the material, these perforations can be placed adjacent to one another (spatial separation varying from sub-micron to several microns as desired). This spatial separation is selected in order to facilitate cutting. In some embodiments the defect line is a “through hole,” which is a hole or an open channel that extends from the top to the bottom of the transparent material. In some embodiments the defect line may not be a continuous channel, and may be blocked or partially blocked by portions or sections of solid material (e.g., glass). As defined herein, the internal diameter of the defect line is the internal diameter of the open channel or the air hole. For example, in the embodiments described herein the internal diameter of the defect line is <500 nm, for example ≦400 nm, or ≦300 nm. The disrupted or modified area (e.g., compacted, melted, or otherwise changed) of the material surrounding the holes in the embodiments disclosed herein, preferably has diameter of <50 μm (e.g., <0.10 μm).

As alluded to above, the workpiece assembly 24 can be used by the controller 100 to control the placement of the defect lines (i.e., perforations, channels) in the x-y plane by moving the laminate relative to the optical assembly 22. In an alternate embodiment of the invention, the laser/optics assemblies are moved relative to the laminated structure 1. Thus, the controller 100 has the capability of forming a three-dimensional pattern of defects in the laminated structure. The defect pattern may include linear portions or contoured paths; in either case, the three-dimensional defect pattern is precisely defined such that the laminated structure can be precisely micromachined to achieve any three-dimensional shape. The linear paths, contours or curvilinear patterns defined by a series of perforations may be regarded as fault lines that correspond to a region of structural weakness in the material. In one embodiment, micromachining includes separation of a part from the material processed by the laser, where the part has a precisely defined shape or perimeter determined by a closed contour of perforations formed through MPA effects induced by the laser. As used herein, the term closed contour refers to a perforation path formed by the laser line, where the path intersects with itself at some location. An internal contour is a path formed where the resulting shape is entirely surrounded by an outer portion of material.

The workpiece 24 surface may include a beam disruption element at the boundary of a predetermined layer. The beam disruption element may be a layer of material or an interface. The beam disruption element may be referred to herein as a laser beam disruption element, disruption element or the like. Embodiments of the beam disruption element may be referred to herein as a beam disruption layer, laser beam disruption layer, disruption layer, beam disruption interface, laser beam disruption interface, disruption interface, or the like.

The disruption element has different optical properties than the material to be cut. For example, the beam disruption element may be a defocusing element, a scattering element, a translucent element, or a reflective element. A defocusing element is an interface or a layer comprising a material that prevents the laser light from forming the laser beam focal line on or below the defocusing element. The defocusing element may be comprised of a material or interface with refractive index inhomogeneities that scatter or perturb the wave front of the optical beam. A translucent element is an interface or layer of material that allows light to pass through, but only after scattering or attenuating the laser beam to lower the energy density sufficiently to prevent formation of a laser beam focal line in portions of the stack on the side of the translucent element that are remote from the laser beam. In one embodiment, the translucent element effects scattering or deviating of at least 10% of the light rays of the laser beam.

More specifically, the reflectivity, absorptivity, defocusing, attenuation, and/or scattering of the disruption element can be employed to create a barrier or impediment to the laser radiation. The laser beam disruption element can be created by several means. If the optical properties of the overall stack system are not of a concern, then one or more thin films can be deposited as a beam disruption layer(s) between the laminate layers, where the one or more thin films absorb, scatter, defocus, attenuate, reflects, and/or dissipates more of the laser radiation than the layer immediately above it to protect layers below the thin film(s) from receiving excessive energy density from the laser source. If the optical properties of the entire laminate structure do matter, the beam disruption element can be implemented as a notch filter or eliminated altogether by the optical system 22 of the present invention. This can be done by several methods: (a) creating structures at the disruption layer or interface (e.g. via thin film growth, thin film patterning, or surface pattering) such that diffraction of incident laser radiation is at a particular wavelength or range of wavelengths occurs; (b) creating structures at the disruption layer or interface (e.g. via thin film growth, thin film patterning, or surface pattering) such that scattering of incident laser radiation occurs (e.g. a textured surface); (c) creating structures at the disruption layer or interface (e.g. via thin film growth, thin film patterning, or surface pattering) such that attenuated phase-shifting of laser radiation occurs; and (d) creating a distributed Bragg reflector via thin-film stack at the disruption layer or interface to reflect only laser radiation.

In reference to the divide/singulation assembly 26, once the defect pattern is formed in the laminate, it is often desirable to divide and/or singulate the laminated structure to form individual components. In some embodiments, the defect pattern by itself may not be enough to separate the part spontaneously, and a secondary step may be necessary. In this case, the divide/singulation assembly 26 may be equipped with a second laser that can be used to create thermal stress to separate the laminate into individual parts. In the case of sapphire, separation can be achieved, after the creation of a fault line, by application of mechanical force or by using a thermal source (e.g., an infrared laser, for example a CO₂ laser) to create thermal stress and force a part to separate from a substrate. Another option is to have the CO₂ laser only start the separation and then finish the separation manually. The optional CO₂ laser separation can be achieved, for example, with a defocused continuous wave (CW) laser emitting at 10.6 μm and with power adjusted by controlling its duty cycle. Focus change (i.e., extent of defocusing up to and including focused spot size) is used to vary the induced thermal stress by varying the spot size. Defocused laser beams include those laser beams that produce a spot size larger than a minimum, diffraction-limited spot size on the order of the size of the laser wavelength. For example, spot sizes of about 7 mm, 2 mm and 20 mm can be used for CO₂ lasers, for example, whose emission wavelength is much smaller at 10.6 μm. In one example embodiment, the distance between adjacent defect lines 120 along the direction of the fault lines 110 can be within a range between 0.5 μm and about 20 μm, but the present invention should not be construed as being limited to this range. As another example, the pitch is in a range between 1.0 μm and about 10 μm for certain glass laminates.

The divide/singulation assembly 26 may also employ, e.g., an acid etching step to separate a laminate workpiece having a glass layer. Parts can also be acid etched to enlarge the holes, i.e., to create vias, that can be metal plated for electrical connections. In one embodiment, for example, the acid used can be 10% HF/15% HNO₃ by volume. The parts can be etched for 53 minutes at a temperature of 24-25° C. to remove about 100 μm of material, for example. The parts can be immersed in this acid bath, and ultrasonic agitation at a combination of 40 kHz and 80 kHz frequencies can used to facilitate penetration of fluid and fluid exchange in the holes. In addition, manual agitation of the part within the ultrasonic field can be made to prevent standing wave patterns from the ultrasonic field from creating “hot spots” or cavitation related damage on the part. The acid composition and etch rate can be intentionally designed to slowly etch the part—a material removal rate of only 1.9 μm/minute, for example. An etch rate of less than about 2 μm/minute, for example, allows acid to fully penetrate the narrow holes and agitation to exchange fresh fluid and remove dissolved material from the holes which are initially very narrow.

As embodied herein and depicted in FIG. 2, a cross-sectional view of an optical system 20 in accordance with one embodiment of the present invention is disclosed. The laminate structure 1 is shown as being perpendicularly aligned to the longitudinal beam axis of the laser 20 so that the focal line 2b and the induced absorption extensive section 2c is normal to the major surfaces 1a, 1b. While the incident beam is shown in this view as being perpendicular, i.e., the incidence angle β is 0°, the optical assembly may be actuated by the controller 100 to provide any desired incidence angle β. The incidence angle β may be between 0° and up to 90°; typically, however, the incidence angle β is between 0° and 45°.

As shown in FIG. 2, the laser radiation 2a emitted by laser assembly 20 is first directed onto a circular diaphragm 22-2 which is completely opaque to the laser radiation used. Diaphragm 22-2 is oriented perpendicular to the longitudinal beam axis and is centered on the central beam of the beam bundle 2a. The diameter of aperture 22-2 is selected in such a way that the beam bundles 2aZ near the center of beam bundle 2a are incident the diaphragm and are completely blocked by it. Only the marginal rays 2aR outside the outer perimeter range of the diaphragm 22-2 are allowed to by-pass the opaque diaphragm 22-2. Thus, the marginal rays 2aR form an annular pattern that is directed onto the lens element 22-1, which, in this embodiment, is designed as a spherically cut, bi-convex lens 7.

Lens 22-1 is centered on the central beam and is designed as a non-corrected, bi-convex focusing lens in the form of a common, spherically cut lens. As an alternative, aspheres or multi-lens systems deviating from ideally corrected systems, which do not form an ideal focal point but a distinct, elongated focal line of a defined length, can also be used (i.e., lenses or systems which do not have a single focal point). The zones of the lens 22-1 thus focus along a focal line 2b, subject to the distance from the lens center. The diameter of aperture 22-2 across the beam direction is approximately 90% of the diameter of the beam bundle (defined by the distance required for the intensity of the beam to decrease to 1/e of the peak intensity) and approximately 75% of the diameter of the lens 22-1 of the optical assembly 22. The focal line 2b of a non-aberration-corrected spherical lens 22-1 generated by blocking out the beam bundles in the center is thus used.

The controller 100 positions the optical assembly 22 relative to the laminate structure 1 so that the focal line 2b (viewed in the direction of the beam) is formed above the surface 1a of the laminate structure 1 and ends before it can emerge from the bottom major surface 1b of the laminate structure 1, i.e. focal line 2b terminates within the laminate structure 1 and does not extend beyond surface 1b. The portions 2aR of the laser beam 20 that emerge from either side of the 22-1 overlap to form the focal line 2b and generate nonlinear absorption in laminate structure 1. This assumes suitable laser intensity along the laser beam focal line 2b; said intensity is ensured by adequate focusing of laser beam 2 on a section of length L (i.e. a line focus of length L), which defines an extensive section 2c (aligned along the longitudinal beam direction) along which an induced nonlinear absorption is generated in the laminate structure 1. The induced nonlinear absorption results in formation of a defect line (e.g., crack, segmented perforation, or channel) in laminate structure 1 along section 2c. The defect formation is configured to extend over the entire length of the extensive section 2c of the induced absorption. The length of section 2c is labeled with reference L. The average diameter or extent of the section of the induced absorption 2c (or the sections in the material of laminate structure 1 undergoing the defect line or crack formation) substantially corresponds to the average diameter δ of the laser beam focal line 2b, that is, an average spot diameter in a range of between about 0.1 μm and about 5 μm.

In this example, the entire laminate structure 1 is transparent to the wavelength λ of laser beam 2 in order to produce induced absorption at the extensive section 2c (i.e., the portion of the focal line 2b within the laminate). The induced absorption arises from the nonlinear effects associated with the high intensity (energy density) of the laser beam within focal line 2b. Of course, one of the features of the present invention relates to the ability to generate a focal line 2b having essentially any predetermined length, and the capability of positioning that focal line 2b at any position within the laminate structure. Accordingly, the present invention is configured to individually cut any layer (or a selected portion of the layer) of the laminate structure 1 to form a three-dimensional pattern within the laminate 1. (See, e.g., FIG. 10). This capability is provided by the laser assembly 20 and the optical assembly 22 under the direction of the controller 100.

To insure high quality (regarding breaking strength, geometric precision, roughness and avoidance of re-machining requirements) of the edge surface after cracking along the perforation contour, the individual focal lines used to form the perforations should be generated using the optical assembly 22 described below (hereinafter, the optical assembly is alternatively also referred to as laser optics). The roughness of the edge surface is determined primarily by the spot size or the spot diameter of the focal line. The surface roughness can be characterized, for example, by a Ra surface roughness statistic (roughness arithmetic average of absolute values of the heights of the sampled surface). In order to achieve a small spot size of, for example, 0.5 μm to 2 μm in case of a given wavelength λ of laser 20 (interaction with the material of laminate structure 1), certain requirements must usually be imposed on the numerical aperture of laser optics 22. These requirements are met by laser optics 22 described below.

In order to achieve the required numerical aperture, the optical assembly 22 must, on one hand, dispose of the required opening for a given focal length, according to the known Abbé formulae (NA=n sin (theta), n: refractive index of the material to be processed, theta: half the aperture angle; and theta=arctan (D/2f); D: aperture, f: focal length). On the other hand, the laser beam must illuminate the optics up to the required aperture, which is typically achieved by means of beam widening using widening telescopes between the laser and focusing optics.

The spot size should not vary too strongly for the purpose of a uniform interaction along the focal line. This can, for example, be ensured (see the embodiment below) by illuminating the focusing optics only in a small, annular area so that the beam opening and thus the percentage of the numerical aperture only vary slightly.

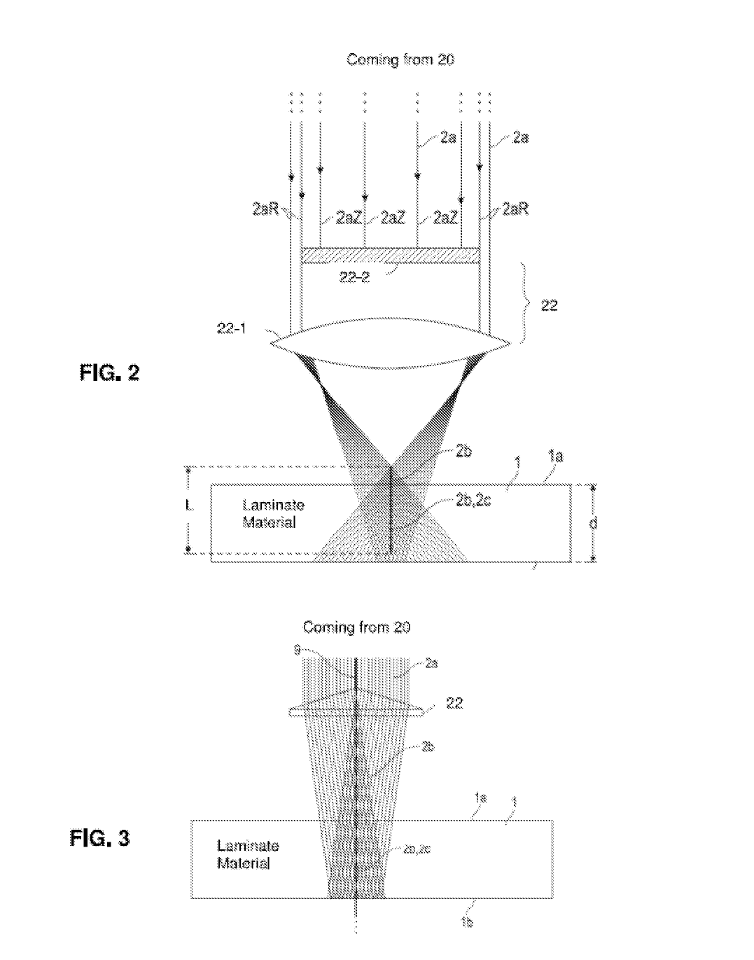

Referring to FIG. 3, a cross-sectional view of an optical system 22 in accordance with a second embodiment of the present invention is disclosed. In this example, a so-called conical prism, also often referred to as axicon, is used to implement the optical assembly 22. An axicon is a special, conically cut lens which transforms an incident spot source on a line along the optical axis into an annular ring, and is thus, another type of Bessel beam generator. The layout of such an axicon is principally known to those skilled in the art; the cone angle in the example is about 10°. The apex of the axicon 22 labeled here with reference 9 is directed towards the laser assembly 20 (incidence direction) and is centered on the laser beam axis. Since the focal line 2b produced by the axicon 22 positioned within its interior, laminate 1 (here aligned perpendicularly to the main beam axis) can be positioned in the beam path directly under axicon 22. Because of the optical characteristics of the axicon, it is possible to shift the laminate structure 1 along the longitudinal beam axis direction while remaining within the range of focal line 2b while the extensive section of induced absorption 2c extends over the entire depth d. In general, the focal line 2b may be produced by optics that have a non-spherical free surface. Thus, aspheres such as an axicon may be used as optical elements of the optical assembly 22.

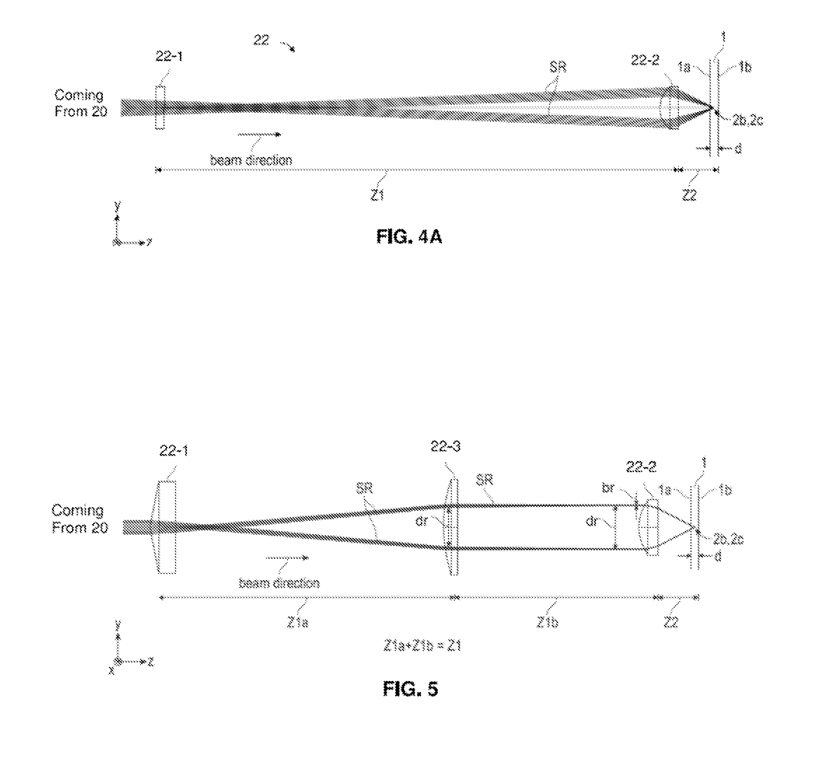

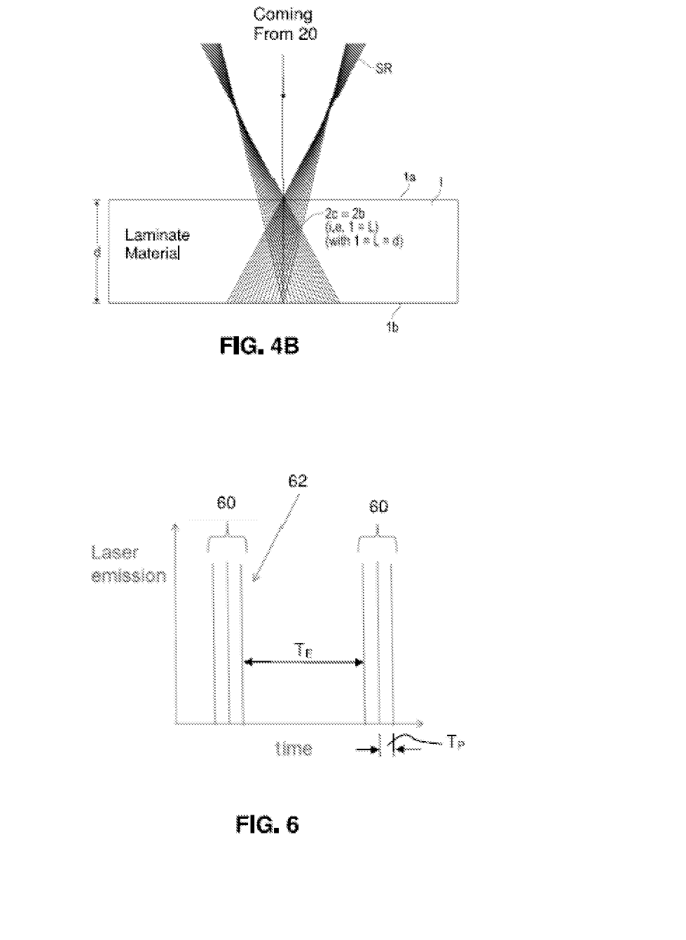

Referring to FIGS. 4A-4B, cross-sectional views of an optical system in accordance with a third embodiment of the present invention are disclosed. In this embodiment, the optical assembly 22 includes an axicon 22-1 (having a cone angle of about 5°) positioned perpendicularly to the laser beam direction and centered on laser beam 20. The apex of the axicon is oriented towards the laser assembly 20. The optical assembly includes a second focusing optical element 22-2, which may be implemented by a plano-convex lens 22-2 that is positioned in the beam direction at a distance z1 from the axicon 22-1 (Note that the curvature of the plano-convex lens 22-2 is oriented towards the axicon). The distance z1, in this example, is approximately 300 mm, and is selected by the controller 100 such that the laser radiation formed by axicon 10 provides an annular ring on the outer radial portion of lens 22-2. The lens 22-2 is configured to focus the annular radiation on the output side at a distance z2. In this example, z2 is approximately 20 mm from lens 22-2. This optical configuration provides a focal line 2b having a defined length (i.e., about 1.5 mm). The effective focal length of lens 22-2 is 25 mm in this embodiment. The annular transformation of the laser beam into a Bessel beam by axicon 22-1 is labeled with the reference SR.

In reference to FIG. 4B, a detail view of the arrangement shown in FIG. 4A is disclosed. The detail view depicts the formation of the focal line 2b and the induced absorption section 2c in the laminate material 1. The controller 100 employs optical elements (22-1, 22-2) that have predetermined optical characteristics, and positions these elements so that the length L of the focal line 2b is identical to the thickness (d) of the laminate structure (or identical to the thickness of a single selected laminate layer or any predetermined portion thereof). Consequently, the controller 100 is configured to exactly position the laminate structure 1 along the laser beam axis so that the focal line 2b is positioned exactly between the two major surfaces 1a and 1b of the laminate 1.

In the embodiment of FIGS. 4A-4B, the focal line 2b is formed at a certain distance from the laser optics 22, such that the greater part of the laser radiation is focused to achieve a desired focal line length disposed at a desired position. As described, this can be achieved by illuminating a primary focusing element 22-2 (lens) with an annular pattern over a particular outer radial region. This arrangement, on the one hand, serves to realize the required numerical aperture and thus the required spot size, while on the other hand, the circle of diffusion diminishes in intensity almost immediately after the required focal line 2b ends (i.e., at the lower major surface 1b). Accordingly, defect formation can be precisely terminated, or within a short distance in the required substrate depth. This feature substantially eliminates the need for placing a beam disruption layer between the laminate substrate layers when making precision cuts. Of course, the combination of axicon 22-1, focusing lens 22-2 meets this requirement. The axicon 22-1 acts in two different ways: (1) it provides an annular illumination ring to the focusing lens 22-2; and (2) the asphericity of axicon 22-1 is selected to form a focal line beyond the focal plane of the lens rather than a focal point in the lens' focal plane. Controller 100 is configured to adjust the length of focal line 2b via the beam diameter on the axicon. The numerical aperture along the focal line, on the other hand, is adjusted via the distance (z1) between the axicon and the lens, and via the cone angle of the axicon. In this way, substantially all of the laser energy can be concentrated in the focal line 2b.

The annular illumination uses the laser power in a substantially optimal way in the sense that most of the laser light is concentrated in the focal line. Moreover, the annular pattern achieves a substantially uniform spot (diameter) size along the entire length of the focal line. Thus, the method of cutting the laminate provides a uniform separation process along the perforations produced by the focal lines.

In another embodiment of the present invention, a focusing meniscus lens or another higher corrected focusing lens (asphere, multi-lens system) may be employed instead of the plano-convex lens 22-2 depicted in FIG. 4A.

As embodied herein and depicted in FIG. 5, a cross-sectional view of an optical system 20 in accordance with a fourth embodiment of the present invention is disclosed. The optical assembly 22 is based on the one depicted in FIG. 4A and further includes a collimating lens 22-3. The collimating lens 22-3 is designed as a plano-convex lens (with its curvature towards the beam direction) and is positioned substantially at the center of laser beam path between axicon 22-1 on the one side, and the plano-convex lens 22-2 on the other side. The distance between the collimating lens 22-3 and the axicon 22-1 is referred to as distance z1a; and the distance between focusing lens 22-2 and the collimating lens 22-3 is referred to as zlb. As before, the distance between the focal line 2b and the focusing lens 22-2 is referred to as z2.

The annular radiation pattern SR that is formed by axicon 22-1 diverges until it is incident the collimating lens 22-3. When the annular radiation pattern SR is incident the collimating lens it is characterized by a diameter dr. The controller 100 is configured to adjust the distance z1b so that the collimating lens 22-3 provides an annular radiation pattern that is characterized by an annular width “br” and a substantially constant annular diameter “dr” when the radiation is incident the focusing lens 22-3. In one example, the present invention achieves a focal line length L of less than 0.5 mm using a typical laser beam diameter of 2 mm, a focusing lens 22-3 with a focal length f=25 mm, a collimating lens 22-2 with a focal length f=150 mm, and choosing distances Z1a=Z1b=140 mm and Z2=15 mm. In some embodiments of the present invention, the average diameter of the focal length 2b (i.e., the spot diameter) is between 0.5 μm and 5 μm.

As embodied herein and depicted in FIG. 6, a diagram illustrating the laser burst emission frame structure in accordance with an embodiment of the present invention is disclosed. As described herein, the laser assembly 20 typically provides a single burst emission 60 consisting of several laser pulses 62; the optical assembly 22 transforms each pulse into a Bessel beam that is configured to form a focal line having a predetermined length. The laser energy applied to the substrate 1 simultaneously ionizes the laminate material along the entire length L of the focal line to form a substantially uniform defect (crack, perforation or channel) having a diameter substantially equal to the diameter of the focal line. The severity of the defect is a function of the laser energy and the number of pulses applied in the burst transmission.

Specifically, the present invention may employ a picosecond laser 20 that creates a “burst” 60 of several pulses 62. Stated differently, each laser burst emission may contain between 2-5 (or more) pulses 62 having a relatively short duration (˜10 psec). The time between pulses 62, i.e., the pulse duration (Tₚ), is between about 1 nsec and about 50 nsec. If the pulse duration Tₚ is approximately 20 nsec, the pulse frequency is about 50 MHz. The pulse duration Tₚ is often governed by the laser cavity design. The time between laser burst emissions 60, i.e., the laser burst emission duty cycle (T_{E}), is much longer, on the order of about 10 μsec. The laser burst emission rate is thus about 100 kHz. The pulse energy delivered to the workpiece material may be within a range between approximately 200-500 μJ. Those skilled in the art will appreciate that the exact timings, pulse durations, and repetition rates can vary depending on the laser design, the laminate materials specification, the type of defects (e.g., a crack or segmented perforation versus a clean channel), and etc. Some of the important laser parameters are the laser wavelength, pulse duration, burst emission duty cycle, the pulse energy and possibly the polarization of the laser. These parameters are selected, as noted herein, such that there is no significant ablation or melting of the laminate layers; instead, the non-linear absorption produces defect formation in the microstructure of the laminate layers.

In conventional Gaussian beam systems, the laser continually pounds away at the workpiece material, which is usually opaque or translucent at the laser wavelength, by drilling the focal point downward into the material. As a result of the linear absorption of the laser light, the workpiece becomes overheated and the undesirable side-effects described in the Background section occur.

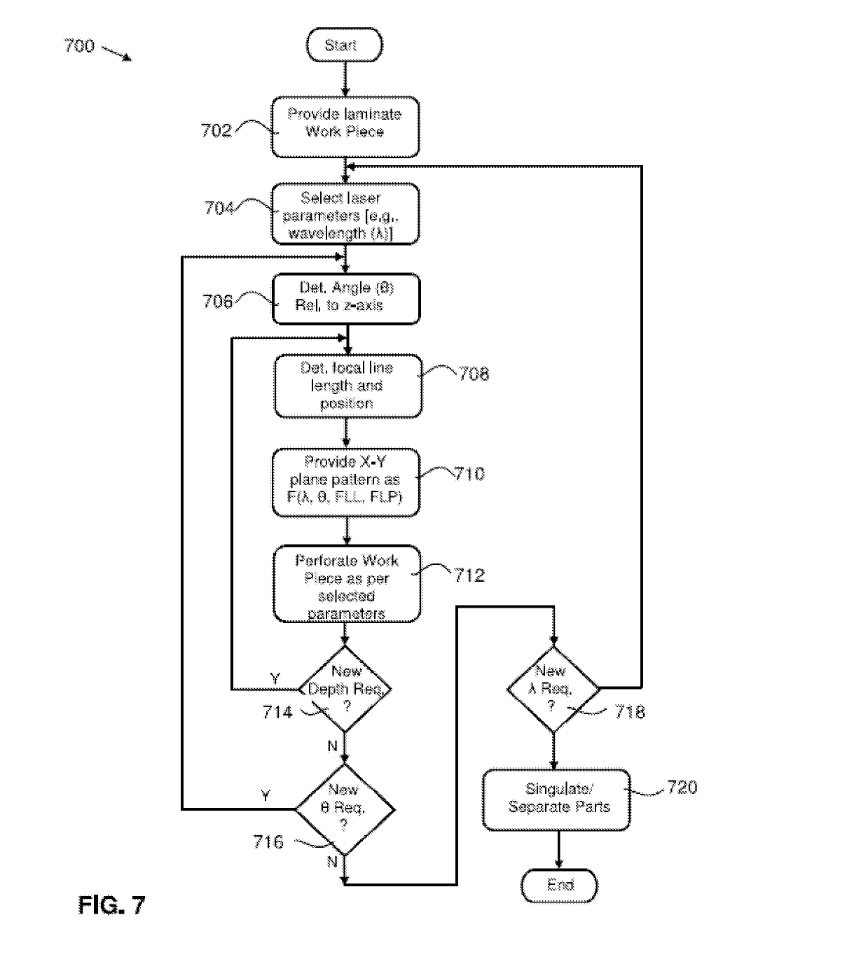

As embodied herein and depicted in FIG. 7, a diagram illustrating a method for cutting laminated structures in accordance with an embodiment of the present invention is disclosed. Briefly stated, the controller 100 is programmed and/or configured to transform a laminated structure 1 by forming a three-dimensional pattern of defects therein. Although the method described herein selects various system parameters in a certain order, the present invention should be construed as being limited by the order of the system parameter selection.

In step 702, therefore, a laminate workpiece is selected having a predetermined number of layers, with each layer being characterized by predetermined material parameters. For instance, each material layer may be transparent at a certain wavelength. Moreover, multiple layers of the laminate structure may be transparent at that wavelength. Thus, in step 704, the controller 100 selects a laser having a predetermined wavelength, pulse duration, burst emission duty cycle, and pulse energy (and possibly the polarization) depending on the material parameters of the laminate layer(s) being cut. Next, the controller determines the incident angle (β) in accordance with the product design. In step 708, the controller 100 actuates the optical assembly to obtain the desired focal length and position of the focal line within the laminate substrate. This example further assumes that the product design requires the formation of a number of defects at this focal length and focal length depth. Thus, it obtains the defect pattern in the x-y plane as a function of the laser parameters (e.g., wavelength), focal line length and focal line depth. In step 712, the controller 100 directs the selected laser to begin emitting burst emissions while the laminate substrate 1 is being moved relative to the laser 20/optics 22 assemblies. Once the planar pattern is formed in the laminate at the selected depth and focal line, the controller 100 determines if the product design requires a different focal line length at a new focal line depth. If so, the controller 100 directs the process back to step 708 and the process is repeated.

Once all of the three-dimensional defects are formed for a given β and a predetermined laser set-up, the controller 100 determines (step 716) if the product design requires defect formation at another incidence angle β. If so, steps 706-714 are repeated for each said incidence angle β.

When the laminated structure includes materials that are transparent at different wavelengths or require different laser settings (e.g., pulse duration, burst emission duty cycle, and pulse energy), the controller 100 is configured and/or programmed to change the laser settings accordingly. See, step 718. This step may require the controller 100 to automatically change the laser in use to one that has the desired wavelength; alternatively, the controller 100 may provide the user with a message via the display 14 (See, FIG. 1) to make the necessary changes manually. In any event, once the new laser parameters are effective, steps 706-716 are repeated as necessary before returning to step 718. If the product design requires a third wavelength (or different laser parameters), the adjustments are made and steps 706-716 are repeated as necessary before again returning to step 718.

As those skilled in the art will appreciate, the controller 100 performs the various steps in method 700 until the three-dimension defect pattern is formed in the laminated structure 1 in accordance with the product design.

In step 720, the controller 100 may perform the optional step of dividing or separating the laminated structure into component parts. (The step 720 is optional because in some cases, the end customer may want to perform the separation and singulation step on its premises for reasons of convenience).

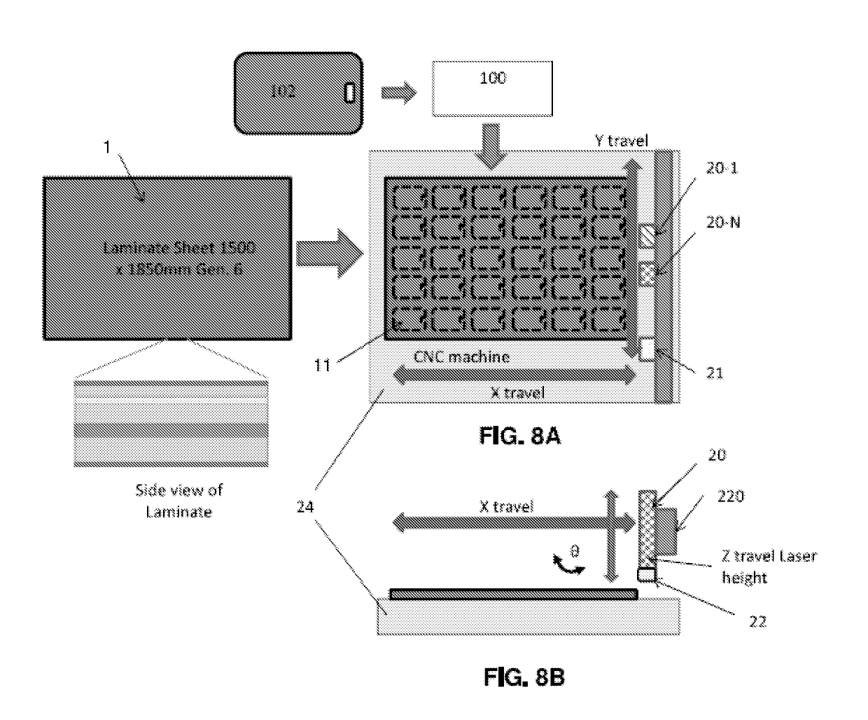

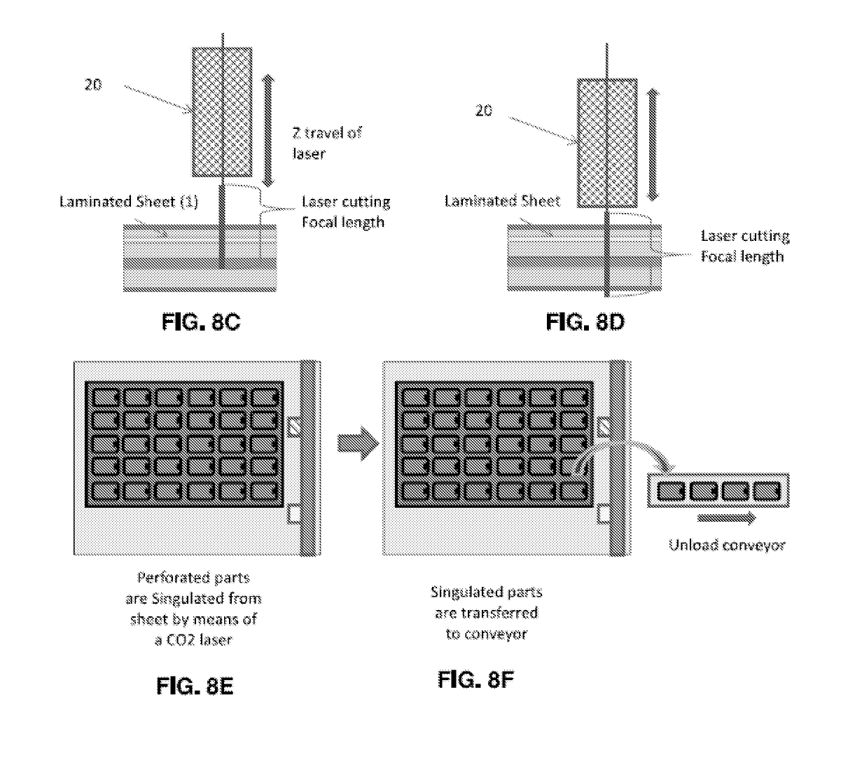

In reference to FIGS. 8A-8F, detailed diagrams illustrating a system and method for cutting laminated structures in accordance with another embodiment of the present invention are disclosed. In this view, a product design 102 is loaded into the controller 100 by way of system I/O 12, by a remote user via communications interface 18 or by other means. Next a laminated sheet 1 is disposed on the workpiece assembly 24, which may be configured as a CNC machine. In FIG. 8A, the apparatus is shown to include N lasers (20-1 . . . 20-N), wherein N is an integer value greater than or equal to one (1). The apparatus 10 also includes a CO₂ laser 21 that may be employed in the separation and singulation step 720. The laser 20N and the optical assembly 22 (not visible in this view) move relative to the laminated structure in the x-y plane as described herein. See, e.g., FIG. 7, steps 710-712.

FIG. 8B is a side view of the apparatus and shows the optical assembly 22 and the laser 20. This view illustrates the ability of the laser/optics to move in the z-direction (i.e., in a direction normal to the major surface of the laminate) and to change the incidence angle β.

FIGS. 8C-8D show the system 10 forming focal lines of various lengths and depths in order to create the three-dimensional defect pattern in the laminated structure 1. FIG. 8E illustrates the use of the CO2 laser to apply an appropriate amount of heat to separate the laminated structure into component parts. In FIG. 8F the singulated parts are unloaded via a conveyor system under the direction of the controller 100. As described herein, the components being unloaded may include, but are not limited to, display glass units, MEMS/NEMS parts, RF components, cover glass units, automotive glass units, architectural glass structures, etc.

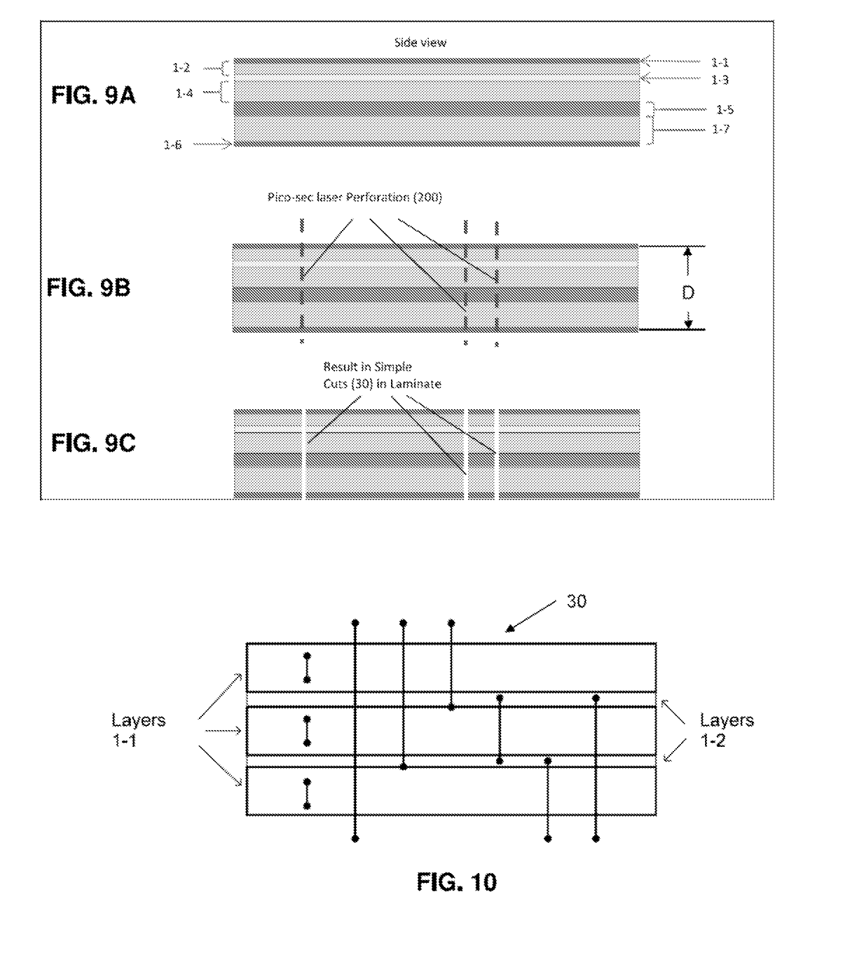

Referring to FIGS. 9A-9C, cross-sectional views illustrating the various process steps depicted in FIGS. 8A-8F are disclosed. In this simplified view, the laminated structure includes seven (7) individual layers (1-1 . . . 1-7). In FIG. 9B, the system 10 has created defects 200 that extend from the top major surface to the lower major surface of the laminate 1. In FIG. 9C, the CO2 laser applies an appropriate amount of heat to complete the cutting process. In an alternative embodiment, the defects 200 could be comprised of a series of closely spaced channels that form a cutting contour. The application of a small amount of mechanical force is enough to complete the cutting action.

In reference to FIG. 10, a cross-sectional diagram illustrating the various types of laminate cuts that can be performed by the system and method of the present invention is disclosed. In this diagram, the laminated substrate 1 includes five (5) separate layers which may be alternating layers of two different materials or five layers of different materials. In either case, the system and method of the present invention is configured to make various kinds of cuts 30 including cutting each layer separately, cutting through the entire laminate structure 1 (as shown in FIGS. 9A-C), or cutting through selected portions of the laminated structure.

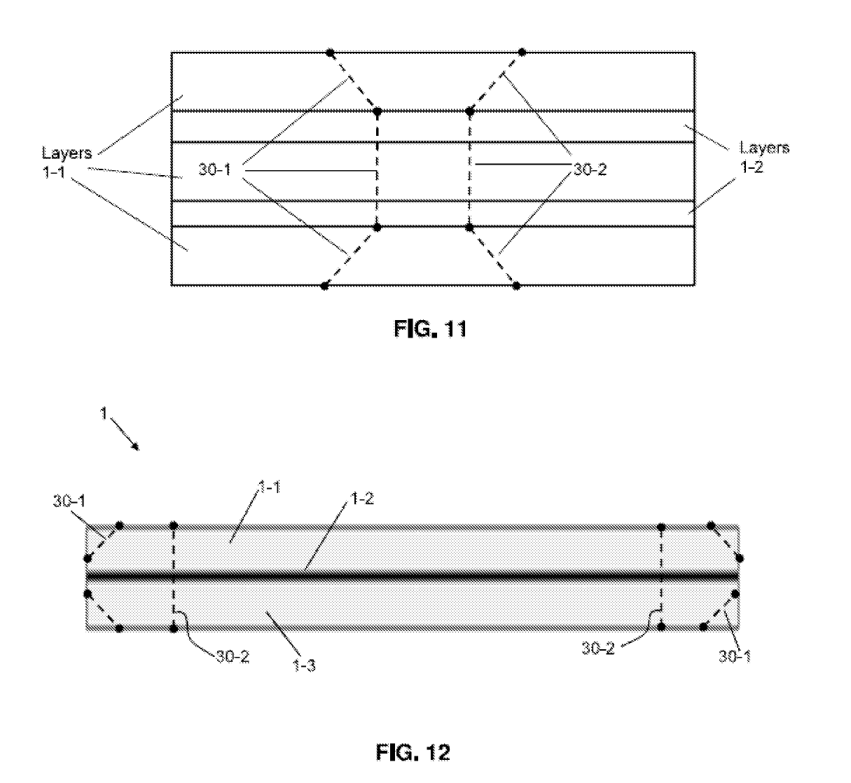

In reference to FIG. 11, a cross-sectional diagram illustrating other types of laminate cuts performed by the system and method of the present invention are disclosed. In this example, several cuts 30 are made with an incident angle β greater than 0° and less than +/−90°. Stated differently, if the middle leg of cut 30-1 is 0° and the upper leg is at 45°, then the lower leg is at an angle of about −45°. Since the angle of each leg can approach about 90°, the incident angle β provided by the laser/optical assemblies (20, 30) has an approximate range of about 180°.

In reference to FIG. 12, a cross-sectional diagram illustrating certain glass laminate cuts performed by the system and method of the present invention is disclosed. In this view, the laminate structure 1 includes an upper glass layer 1-1, a middle polymer layer 1-2 and a bottom glass layer 1-3. As before, the incident angle β provided by the laser/optical assemblies (20, 30) has an approximate range of about 180°. This allows the system 10 of the present invention to provided tailored cuts 30-1 at the edges of the laminate 1 and provide through-cuts where desired.

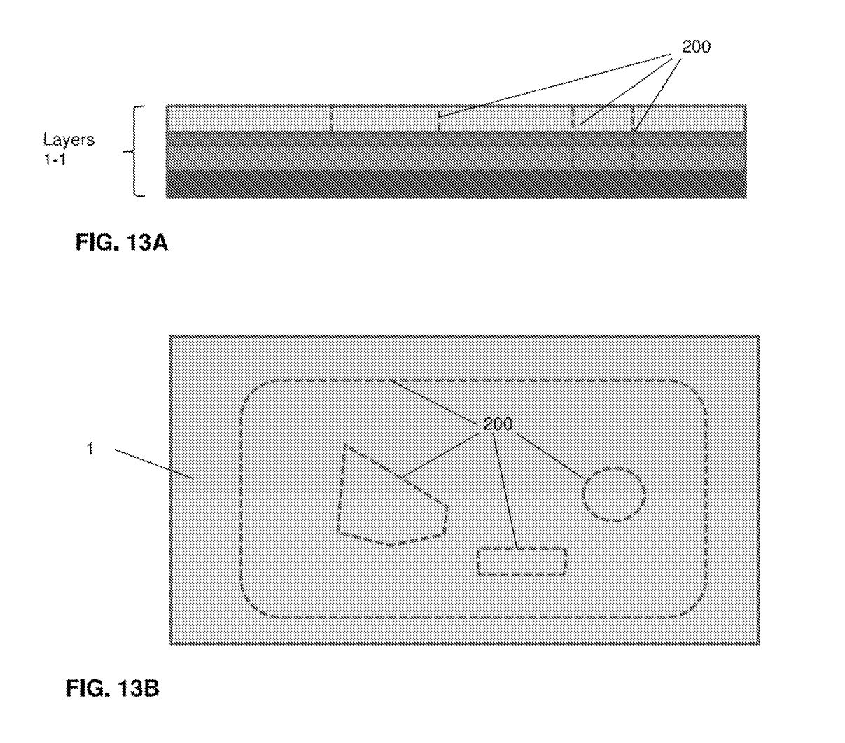

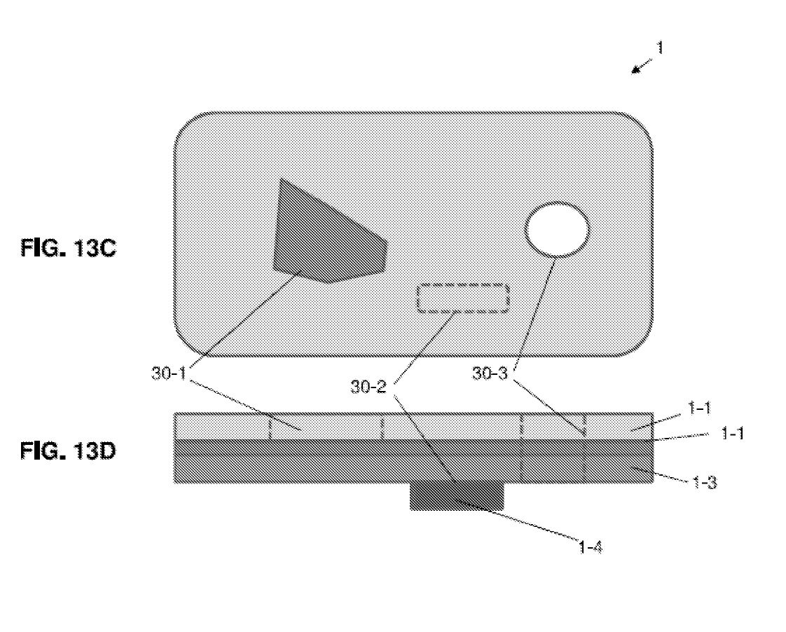

In reference to FIGS. 13A-13D, various diagrammatic views illustrating other types of laminate cuts that can be performed by the system and method of the present invention are disclosed. FIG. 12A is a cross-sectional view that shows the location of defects 200 and FIG. 12B shows the locations of these defects 200 in plan view. FIG. 12C shows the location of the resultant cuts in plan view, whereas FIG. 12D shows the same cuts 30 in a cross-sectional view. In this case the system 10 removed a pentagonal portion of the upper laminate layer in cut 30-1. In cut 30-2, the cut removed most of the bottom layer in order to leave a proud layer portion 1-4. The third cut 30-3 shows a curvilinear through hole.

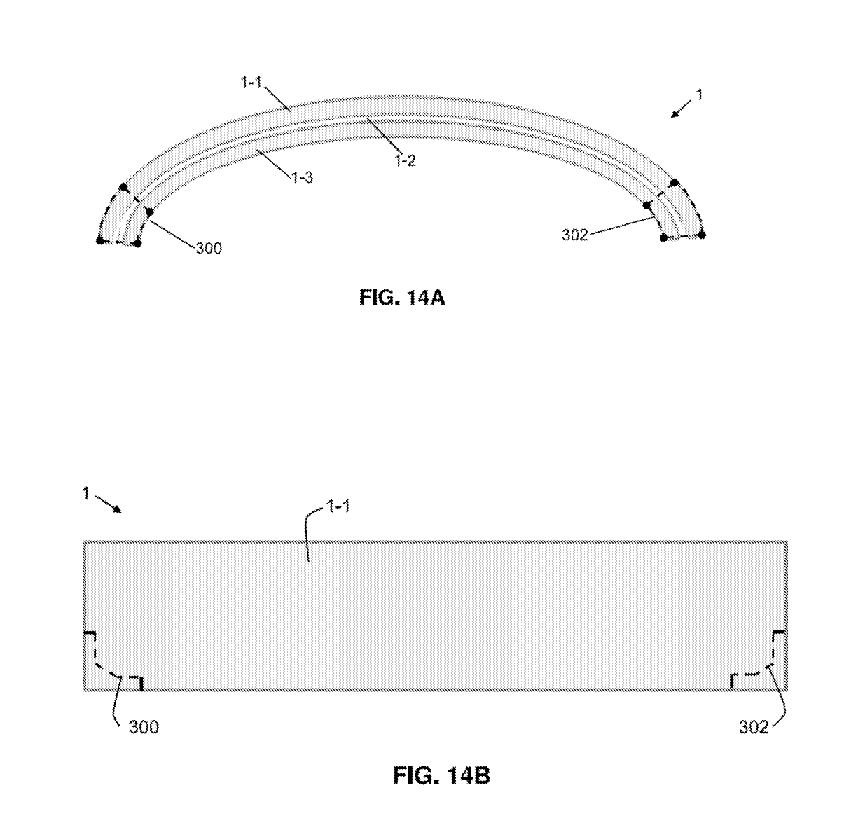

Referring to FIGS. 14A-14B, various diagrammatic views illustrating additional types of three-dimensional glass laminate cuts performed by the system and method of the present invention are disclosed. In this view, a three-dimensional glass laminate structure 1 is depicted.

FIG. 14A is an end-view of the structure 1 and FIG. 14B shows the laminate 1 in plan view. In one embodiment, the three-dimensional glass structure 1 is configured as an automotive glass windshield. As described above, the system 10 is configured to remove three-dimensional portions 300, 302 from the glass laminate structure 1.

It will be apparent to those skilled in the art that various modifications and variations can be made without departing from the spirit or scope of the claims.

What is claimed is:

1. A system for processing a laminated structure, the laminated structure comprising a plurality of laminate layers, the system comprising:
a laser assembly configured to provide a plurality of laser burst emissions, each laser burst emission of the plurality of laser burst emissions having predetermined laser characteristics;
an optical assembly coupled to the laser assembly, the optical assembly being configured to focus each laser burst emission to a predetermined focal line, the optical assembly being adjustable such that each predetermined focal line is characterized by predetermined focal line parameters and disposed at a predetermined position relative to the optical assembly;
a workpiece holder configured to hold the laminated structure, the workpiece holder or the optical assembly being configured to provide a relative motion between the laminated structure and the optical assembly; and
a controller coupled to the laser assembly, the optical assembly or the workpiece holder, the controller being configured to execute instructions representing a predetermined design, the controller being configured to dynamically select the predetermined laser characteristics and the predetermined focal line parameters for each laser burst emission such that a defect having predetermined dimensions is formed at a predetermined location within the laminated structure, the controller being further configured to select the relative motion such that the plurality of laser burst emissions form a plurality of said defects corresponding to a three-dimensional defect pattern within the laminated structure, the predetermined laser characteristics or the predetermined focal line parameters being selected each said defect is substantially generated by induced absorption.

2. The system of claim 1, wherein the laser assembly includes a plurality of laser devices individually selectable by the controller, each of the plurality of laser devices being characterized by a wavelength, each wavelength corresponding to at least one portion of the plurality of laminate layers substantially transparent at the wavelength.

3. The system of claim 1, wherein the predetermined laser characteristics are selected from a group of laser characteristics that include wavelength, power level, pulse duration, a number of laser pulses per laser burst emission, and a laser burst emission rate.

4. The system of claim 3, wherein the wavelength is selected such that at least a portion of the laminate structure is substantially transparent to the laser burst emission at the selected wavelength.

5. The system of claim 3, wherein each defect of the plurality of defects is implemented with a predetermined defect modality that is a function of at least one of the power level, the pulse duration, the number of laser pulses per laser burst emission, or the laser burst emission rate.

6. The system of claim 5, wherein the predetermined defect modality is selected from a group of modalities including a crack, a segmented perforation or a channel formed in the laminated structure.

7. The system of claim 1, wherein the predetermined focal line parameters include a focal line length, a focal line intensity or a focal line diameter.

8. The system of claim 7, wherein the focal line length is selected to substantially correspond to a width of a selected layer of the plurality of laminate layers, a width of selected multiple layers of the plurality of laminate layers, or a width of a selected portion of the laminated structure.

9. The system of claim 7, wherein each defect of the plurality of defects is implemented with a predetermined defect modality that is a function of at least one of the focal line length, the focal line intensity or the focal line diameter.

10. The system of claim 9, wherein the predetermined defect modality is selected from a group of modalities including a crack, a segmented perforation or a channel formed in the laminated structure.

11. The system of claim 1, wherein a length of a defect of the plurality of defects substantially corresponds to a portion of the focal line formed within the laminated structure during induced absorption.

12. The system of claim 1, wherein the plurality of laminate layers are comprised of materials selected from a group of materials that include glass, plastic, polymer, rubber, semiconductor, softboard material, ceramic, metallic materials, piezoelectric materials, gaseous materials, liquid crystal materials, indium tin oxide material or electrochromic glass.

13. The system of claim 1, further comprising a separation mechanism configured to divide the laminated structure into a plurality of components in accordance with the plurality of defects to implement the predetermined design.

14. The system of claim 13, wherein the separation mechanism includes CO₂ laser device configured to separate the laminated structure along lines corresponding to the plurality of defects or a device configured to apply a substantially uniform force to the plurality of defects.

15. The system of claim 1, wherein individual defects within the three dimensional defect pattern are separated by a distance greater than about 0.5 μm and less than about 20 μm.

16. The system of claim 1, wherein the induced absorption includes multi-photon absorption (MPA).

17. A method comprising:
providing a laminated structure including a plurality of laminate layers, a first portion of the plurality of laminate layers being transparent at a first optical wavelength and at least one second portion of the plurality of laminate layers being transparent at least one second optical wavelength;
selectively directing a first laser beam and at least one second laser beam, respectively, toward the laminated structure, the first laser beam being characterized by the first wavelength and the at least one second laser beam being characterized by the at least one second wavelength;
selectively focusing the first laser beam at a plurality of first predetermined focal lines while moving the laminated structure relative to the first laser beam to form a first three-dimensional defect pattern in the first portion by induced absorption; and
selectively focusing the at least one second laser beam at a plurality of second predetermined focal lines while moving the laminated structure relative to the at least one second laser beam to form at least one second three-dimensional defect pattern in the at least one second portion by induced absorption, the first three-dimensional defect pattern and the at least one second three-dimensional defect pattern forming a composite defect pattern within the laminated substrate.

18. The method of claim 17, wherein the first portion includes a plurality of first laminate layers transparent at the first wavelength.

19. The method of claim 17, wherein the at least one second portion includes a plurality of second laminate layers transparent at a second wavelength and at least one third laminate layer transparent at a third wavelength.

20. The method of claim 17, wherein the at least one second optical wavelength includes a plurality of second optical wavelengths.

21. The method of claim 17, wherein each defect in the composite defect pattern is implemented with a predetermined defect modality that is a function of at least one of a laser power level, a laser pulse duration, a number of laser pulses per laser burst emission, or a laser burst emission rate.

22. The method of claim 21, wherein the predetermined defect modality is selected from a group of modalities including a crack, a segmented perforation or a channel within the laminated structure.

23. The method of claim 17, further comprising the step of singulating the laminated structure to separate the laminated structure into a plurality of sub-components corresponding to the composite defect pattern.

24. The method of claim 17, wherein the plurality of laminate layers are comprised of materials selected from a group of materials that include glass, plastic, polymer, rubber, semiconductor, softboard material, ceramic, metallic materials, piezoelectric materials, gaseous materials, liquid crystal materials, indium tin oxide material or electrochromic glass.

25. The method of claim 17, wherein the induced absorption includes multi-photon absorption (MPA).

26. A method for processing a laminated structure, the laminated structure comprising a plurality of laminate layers, the method comprising:
(a). providing a system that includes a laser assembly configured to provide a plurality of laser burst emissions, each laser burst emission of the plurality of laser burst emissions having laser characteristics, the system further including an optical assembly coupled to the laser assembly, the optical assembly being configured to focus each laser burst emission to a predetermined focal line, the optical assembly being adjustable such that each predetermined focal line is characterized by focal line parameters and disposed at a predetermined position relative to the optical assembly;
(b) selecting the laser characteristics and the focal line parameters for each laser burst emission such that a defect having predetermined dimensions is formed at a predetermined location within the laminated structure; and
(c) translating the workpiece and the optical assembly relative to each other along a contour such that the plurality of laser burst emissions form a plurality of the defects corresponding to a multi-dimensional defect pattern within the laminated structure, the predetermined laser characteristics or the predetermined focal line parameters being selected each said defect is substantially generated by induced absorption.

27. The method of claim 26, further comprising the steps of repeating steps (b) and (c) based on at least one material characteristic of at least one of the plurality of laminate layers requires a subsequent selection of the predetermined laser characteristics and the predetermined focal line parameters.

28. The method of claim 26, wherein the selected laser characteristics include a wavelength, the wavelength being selected such that at least a portion of the laminate structure is substantially transparent to the laser burst emission at the selected wavelength.

29. The method of claim 26, wherein each defect of the plurality of defects is implemented with a predetermined defect modality that is a function of the selected laser characteristics or the selected focal line parameters.

30. The method of claim 29, wherein the selected laser characteristics are selected from a group of laser characteristics that include wavelength, pulse energy, pulse duration, a number of laser pulses per laser burst emission, and a laser burst emission rate, and wherein the selected focal line parameters are selected from a group of focal line parameters including a focal line length, a focal line intensity or a focal line diameter.

31. The method of claim 29, wherein the predetermined defect modality is selected from a group of modalities including a crack, a segmented perforation or a channel formed in the laminated structure.

32. The method of claim 29, wherein the focal line length is selected to substantially correspond to a width of a selected layer of the plurality of laminate layers, a width of selected multiple layers of the plurality of laminate layers, or a width of a selected portion of the laminated structure.

33. The method of claim 23, wherein a length of a defect of the plurality of defects substantially corresponds to a portion of the focal line formed within the laminated structure during induced absorption.

34. The method of claim 17, wherein the step of singulating includes the step of applying a CO₂ laser to the laminate substrate.

35. The method of claim 17, wherein individual defects within the three dimensional defect pattern are separated by a distance greater than about 0.5 μm and less than about 20 μm.

36. The method of claim 17, wherein the induced absorption includes multi-photon absorption (MPA).
